(19) United States
(12) Patent Application Publication
(10) Pub. No.: US 2014/0254308 A1
(43) Pub. Date: Sep. 11, 2014

(54) IDENTIFYING REFLECTION ACOUSTIC SIGNALS

(71) Applicant: WESTERNGECO L.L.C., HOUSTON, TX (US)

(72) Inventor: KENNETH E. WELKER, OSLO (NO)

(73) Assignee: WESTERNGECO L.L.C., HOUSTON, TX (US)

(21) Appl. No.: 14/102,246

(22) Filed: Dec. 10, 2013

Related U.S. Application Data
(60) Provisional application No. 61/738,211, filed on Dec. 17, 2012.

(51) Int. Cl. G01V 1/00

(52) U.S. Cl. CPC G01V 1/001
USPC 367/14

(57) ABSTRACT

Various implementations described herein are directed to identifying reflected acoustic signals. In one implementation, a method may include receiving initial positions of an acoustic positioning source and an acoustic positioning receiver of an acoustic positioning system in a seismic spread. The method may also include calculating an expected travel difference between the acoustic positioning source and the acoustic positioning receiver. The method may further include receiving an acoustic positioning signal from the acoustic positioning receiver. The method may additionally include calculating an actual travel difference between the acoustic positioning source and the acoustic positioning receiver based on the acoustic positioning signal. The method may further include comparing the actual travel difference to the expected travel difference. The method may also include identifying whether the acoustic positioning signal is a reflected positioning signal based on the comparison.

### CROSS-REFERENCE TO RELATED APPLICATIONS

This application claims the benefit of U.S. Provisional Patent Application Ser. No. 61/738,211 filed Dec. 17, 2012, which is incorporated herein by reference in its entirety.

### BACKGROUND

In a seismic survey, a plurality of seismic sources, such as explosives, vibrators, airguns or the like, may be sequentially activated near the surface of the earth to generate energy (i.e., seismic waves) which may propagate into and through the earth. The seismic waves may be reflected back by geological formations within the earth, and the resultant seismic wavefield may be sampled by a plurality of seismic receivers, such as geophones, hydrophones and the like. Each receiver may be configured to acquire seismic data at the receiver's location, normally in the form of a seismogram representing the value of some characteristic of the seismic wavefield against time. The acquired seismograms or seismic data may be transmitted wirelessly or over electrical or optical cables to a recorder system. The recorder system may then store, analyze, and/or transmit the seismic data. This data may be used to generate an image of subsurface formations in the earth and may also be used to detect the possible presence of hydrocarbons, changes in the subsurface formations and the like.

For correct seismic imaging of the sub-bottom beneath the survey area, an accurate determination of the position of both the air gun sources and the seismic receivers may be used. In particular, accurate determination of streamer positions may be used to avoid high risk operational situations such as streamer tangling. The tangling may be caused by strong water currents in the sea when more than one cable is hooked up and connected. Resolving such tangling scenarios may be complex and may expose the seismic crew to hazardous in-sea operations, in addition to being quite costly.

### SUMMARY

Described herein are implementations of various technologies and techniques for identifying reflected acoustic signals. In one implementation, a method may include receiving initial positions of an acoustic positioning source and an acoustic positioning receiver of an acoustic positioning system in a seismic spread. The method may also include calculating an expected travel difference between the acoustic positioning source and the acoustic positioning receiver. The method may further include receiving an acoustic positioning signal from the acoustic positioning receiver. The method may additionally include calculating an actual travel difference between the acoustic positioning source and the acoustic positioning receiver based on the acoustic positioning signal. The method may further include comparing the actual travel difference to the expected travel difference. The method may also include identifying whether the acoustic positioning signal is a reflected positioning signal based on the comparison.

In another implementation, a non-transitory computer-readable medium may have stored computer-executable instructions which, when executed by a computer, cause the computer to receive initial positions of an acoustic positioning source and an acoustic positioning receiver of an acoustic positioning system in a seismic spread. The computer-executable instructions may also cause the computer to calculate an expected travel difference between the acoustic positioning source and the acoustic positioning receiver. The computer-executable instructions may further cause the computer to receive an acoustic positioning signal from the acoustic positioning receiver. The computer-executable instructions may additionally cause the computer to calculate an actual travel difference between the acoustic positioning source and acoustic positioning receiver based on the acoustic positioning signal. The computer-executable instructions may further cause the computer to compare the actual travel difference to the expected travel difference. The computer-executable instructions may also cause the computer to identify whether the one or more acoustic positioning signals are reflected positioning signals based on the comparison.

In another implementation, a system may include a processor and a memory having program instructions executable by the processor. The program instructions, when executed by the processor, may cause the processor to receive initial positions of an acoustic positioning source and an acoustic positioning receiver of an acoustic positioning system in a seismic spread. The program instructions, when executed by the processor, may also cause the processor to calculate an expected travel difference between the acoustic positioning source and the acoustic positioning receiver. The program instructions, when executed by the processor, may further cause the processor to receive a first acoustic positioning signal and a second acoustic positioning signal from the acoustic positioning receiver. The program instructions, when executed by the processor, may additionally cause the processor to calculate an actual travel difference between the acoustic positioning source and acoustic positioning receiver based on the first and second acoustic positioning signals. The program instructions, when executed by the processor, may further cause the processor to compare the actual travel difference to the expected travel difference. The program instructions, when executed by the processor, may also cause the processor to identify whether the first acoustic positioning signal, the second acoustic positioning signal or both are reflected positioning signals based on the comparison.

The above referenced summary section is provided to introduce a selection of concepts in a simplified form that are further described below in the detailed description section. The summary is not intended to be used to limit the scope of the claimed subject matter. Furthermore, the claimed subject matter is not limited to implementations that solve any disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate the various implementations described herein and are not meant to limit the scope of various techniques described herein.

FIG. 1 illustrates a schematic diagram of a marine-based seismic acquisition system for use in a seismic survey in accordance with implementations of various techniques described herein.

FIG. 2 illustrates a perspective view of a section of a seismic streamer with acoustic positioning sources and the acoustic positioning receivers in accordance with implementations of various techniques described herein.

FIG. 3 illustrates a flow diagram of a method for identifying reflection positioning signals in one or more data records for one or more pairs of acoustic positioning receivers and acoustic positioning sources in accordance with implementations of various techniques described herein.

FIG. 4 illustrates a travel distance model for acoustic positioning signals for an acoustic positioning source and an acoustic positioning receiver on a seismic streamer in accordance with implementations of various techniques described herein.

FIG. 5 illustrates a graphical representation of the difference in estimated travel distance for the signals for each pair of acoustic positioning sources and acoustic positioning receivers in accordance with implementations of various techniques described herein

FIG. 6 illustrates a computing system in which various implementations of various techniques described herein may be implemented.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

It is specifically intended that the claims not be limited to the implementations and illustrations contained herein, but include modified forms of those implementations including portions of the implementations and combinations of elements of different implementations as come within the scope of the following claims.

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to obscure aspects of the embodiments.

It will also be understood that, although the terms first, second, etc. may be used herein to describe various elements, these elements should not be limited by these terms. These terms are used to distinguish one element from another. For example, a first object could be termed a second object, and, similarly, a second object could be termed a first object, without departing from the scope of the claims. The first object and the second object are both objects, respectively, but they are not to be considered the same object.

The terminology used in the description of the present disclosure herein is for the purpose of describing particular implementations and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses one or more possible combinations of one or more of the associated listed items. It will be further understood that the terms “includes” and/or “including,” when used in this specification, specify the presence of stated features, integers, operations, elements, and/or components, but do not preclude the presence or addition of one or more other features, integers, operations, elements, components and/or groups thereof.

As used herein, the terms “up” and “down;” “upper” and “lower;” “upwardly” and downwardly;” “below” and “above;” and other similar terms indicating relative positions above or below a given point or element may be used in connection with some implementations of various technologies described herein. However, when applied to equipment and methods for use in wells that are deviated or horizontal, or when applied to equipment and methods that when arranged in a well are in a deviated or horizontal orientation, such terms may refer to a left to right, right to left, or other relationships as appropriate.

It should also be noted that in the development of any such actual implementation, numerous decisions specific to circumstance may be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The terminology and phraseology used herein is solely used for descriptive purposes and should not be construed as limiting in scope. Language such as “having,” “containing” or “involving,” and variations thereof, is intended to be broad and encompass the subject matter listed thereafter, equivalents and additional subject matter not recited.

Furthermore, the description and examples are presented solely for the purpose of illustrating the different embodiments, and should not be construed as a limitation to the scope and applicability. While any composition or structure may be described herein as having certain materials, it should be understood that the composition could optionally include two or more different materials. In addition, the composition or structure may also include some components other than the ones already cited. It should also be understood that throughout this specification, when a range is described as being useful, or suitable, or the like, it is intended that any value within the range, including the end points, is to be considered as having been stated. Furthermore, respective numerical values should be read once as modified by the term “about” (unless already expressly so modified) and then read again as not to be so modified unless otherwise stated in context. For example, “a range of from 1 to 10” is to be read as indicating a respective possible number along the continuum between about 1 and about 10. In other words, when a certain range is expressed, even if a few specific data points are explicitly identified or referred to within the range, or even when no data points are referred to within the range, it is to be understood that the inventors appreciate and understand that any data points within the range are to be considered to have been specified, and that the inventors have possession of the entire range and points within the range.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

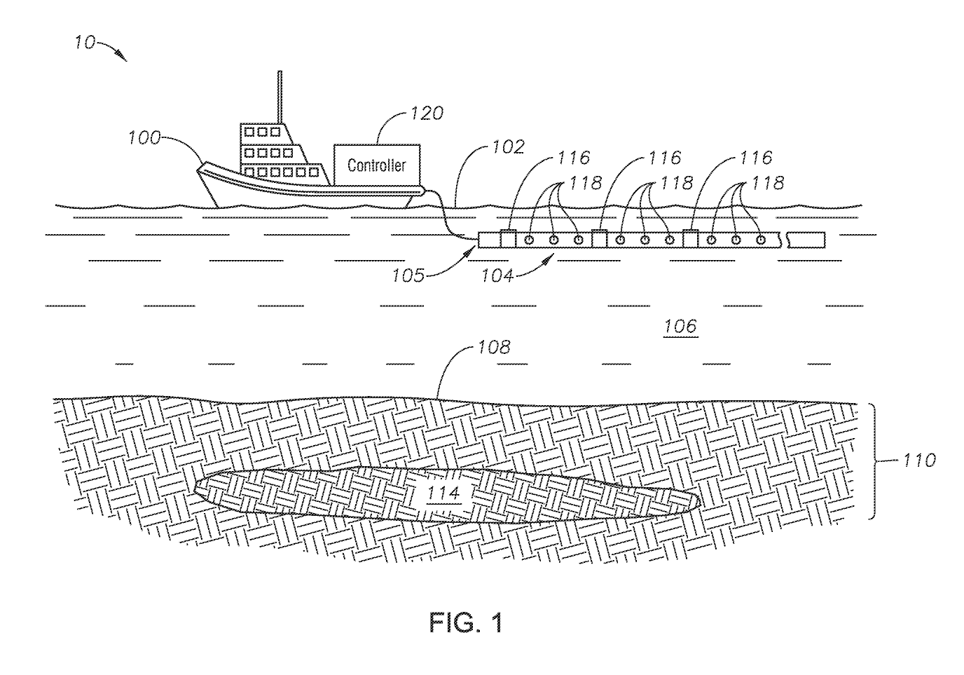

One or more implementations of various techniques for identifying reflected acoustic signals will now be described in more detail with reference to FIGS. 1-6 in the following paragraphs.

### Seismic Acquisition System

FIG. 1 illustrates a schematic diagram of a marine-based seismic acquisition system 10 for use in a seismic survey in accordance with implementations of various techniques described herein. In system 10, survey vessel 100 tows one or more seismic streamers 105 (one streamer 105 being depicted in FIG. 1) behind the vessel 100. In one implementation, streamers 105 may be arranged in a spread 104 in which multiple streamers 105 are towed in approximately the same plane at the same depth. Although various techniques are described herein with reference to a marine-based seismic acquisition system shown in FIG. 1, it should be understood that other marine-based seismic acquisition system configurations may also be used. For instance, the streamers 105 may be towed at multiple planes and/or multiple depths, such as in an over/under configuration. In one implementation, the streamers 105 may be towed in a slanted configuration, where fronts of the streamers are towed shallower than tail ends of the streamers.

Seismic streamers 105 may be several thousand meters long and may contain various support cables, as well as wiring and/or circuitry that may be used to facilitate communication along the streamers 105. In general, each streamer 105 may include a primary cable where seismic receivers that record seismic signals may be mounted. In one implementation, seismic receivers may include hydrophones that acquire pressure data. In another implementation, seismic receivers may include multi-component sensors such that each sensor is capable of detecting a pressure wavefield and at least one component of a particle motion that is associated with acoustic signals that are proximate to the sensor. Examples of particle motions include one or more components of a particle displacement, one or more components (i.e., inline (x), crossline (y) and vertical (z) components) of a particle velocity and one or more components of a particle acceleration.

Depending on the particular survey need, the multi-component seismic receiver may include one or more hydrophones, geophones, particle displacement sensors, particle velocity sensors, accelerometers, pressure gradient sensors or combinations thereof. In one implementation, the multi-component seismic receiver may be implemented as a single device or may be implemented as a plurality of devices.

Marine-based seismic data acquisition system 10 may also include one or more seismic sources, such as air guns and the like. In one implementation, seismic sources may be coupled to, or towed by, the survey vessel 100. Alternatively, seismic sources may operate independently of the survey vessel 100 in that the sources may be coupled to other vessels or buoys.

As seismic streamers 105 are towed behind the survey vessel 100, acoustic signals, often referred to as “shots,” may be produced by the seismic sources and are directed down through a water column 106 into strata 110 beneath a water bottom surface 108. Acoustic signals may be reflected from the various subterranean geological formations, such as formation 114 depicted in FIG. 1. The incident acoustic signals that are generated by the sources may produce corresponding reflected acoustic signals, or pressure waves, which may be sensed by seismic sensors of the seismic streamers 105.

The seismic sensors may generate signals, called “traces,” which indicate the acquired measurements of the pressure wavefield and particle motion. The traces (i.e., seismic data) may be recorded and may be processed by a signal processing unit or a controller 120 deployed on the survey vessel 100.

The goal of the seismic acquisition may be to build up an image of a survey area for purposes of identifying subterranean geological formations, such as the geological formation 114. Subsequent analysis of the image may reveal probable locations of hydrocarbon deposits in subterranean geological formations. In one implementation, portions of the analysis of the image may be performed on the seismic survey vessel 100, such as by the controller 120.

A particular seismic source may be part of an array of seismic source elements (such as air guns, for example) that may be arranged in strings (gun strings, for example) of the array. Regardless of the particular composition of the seismic sources, the sources may be fired in a particular time sequence during the survey. Although FIG. 1 illustrates a marine-based seismic acquisition system, the marine-based seismic acquisition system is merely provided as an example of a seismic acquisition system that may be used with the methods described herein. It should be noted that the methods described herein may also be performed on a seabed-based seismic acquisition system, or a transition zone-based seismic acquisition system.

### Acoustic Positioning System

### System

In addition to the seismic sources and receivers, an acoustic positioning system may be used to determine the positions of seismic acquisition equipment used in the seismic acquisition system 10, such as the seismic streamers 105 and the seismic receivers disposed thereon. The acoustic positioning system may include one or more acoustic positioning sources 116 and one or more acoustic positioning receivers 118. In one implementation, the acoustic positioning sources 116 and the acoustic positioning receivers 118 may be disposed along the one or more seismic streamers 105. In such an implementation, and as described further below, power and/or control electronics may be incorporated into the one or more seismic streamers 105 as well. In a further implementation, the acoustic positioning system may be a stand-alone system with separate power supply and communication telemetry links to the survey vessel 100.

In one implementation, the acoustic positioning receivers 118 may be the same as the seismic receivers described above or some subset of the seismic receivers. The acoustic positioning sources 116 may be higher frequency acoustic sources, as opposed to the seismic sources described above that may be used for performing a seismic survey operation and may be of a lower frequency. The acoustic positioning sources 116 may include an acoustic transmitter or any other implementation known to those skilled in the art. In some implementations, the acoustic positioning source 116 and the acoustic positioning receiver may be combined into a single physical unit. In some implementations, an acoustic positioning source 116 and an acoustic positioning receiver 118 may be combined into one transducer unit. In such an implementation, the transducer unit may act as an acoustic positioning source 116, an acoustic positioning acoustic positioning receiver 118, or both.

The controller 120 may be configured to control activation of the acoustic positioning sources 116 of the acoustic positioning system. In particular, and as further discussed below with respect to the operation of the acoustic positioning system, the acoustic positioning sources 116 may produce one or more acoustic positioning signals that may be recorded by the acoustic positioning receivers 118. In one implementation, an acoustic positioning receiver 118 may detect acoustic positioning signals from an acoustic positioning source 116 located within the same seismic streamer 105 as the acoustic positioning receiver 118. In another implementation, an acoustic positioning receiver 118 may detect acoustic positioning signals from an acoustic positioning source 116 located within a different seismic streamer 105 as the acoustic positioning receiver 118.

As also discussed below with respect to the operation of the acoustic positioning system, the controller 120 may be configured to process the acoustic positioning signals collected by the acoustic positioning receivers 118. In particular, processing an acquired acoustic positioning signal may yield the travel time of the signal between an acoustic positioning source 116 and an acoustic positioning receiver 118. In turn, the travel time may be used to derive the travel distance of the acoustic positioning signal between the acoustic positioning source 116 and the acoustic positioning receiver 118. This travel distance can then be used to calculate the relative positions of the acoustic positioning source 116 and/or the acoustic positioning receiver 118 in the seismic streamer 105. A distance between relative positions of an acoustic positioning source 116 and an acoustic positioning receiver 118 may be referred to as a range.

In one implementation, the controller 120 may process the relative positions and other information to produce (or update) a positioning model to enable estimation of positioning of the seismic acquisition equipment (e.g., position of a seismic streamer 105, depth of a seismic streamer 105, distances between seismic receivers, etc.). In another implementation, calculating the relative positions of acoustic positioning sources 116 and acoustic positioning receivers 118 in the same seismic streamer 105 may be referred to as inline ranging. In such an implementation, inline ranging may be used to provide a measurement of an amount of stretch in a seismic streamer 105 due to the tension of being towed. In yet another implementation, calculating the relative positions of acoustic positioning sources 116 and acoustic positioning receivers 118 of different seismic streamers 105 may be referred to as crossline ranging.

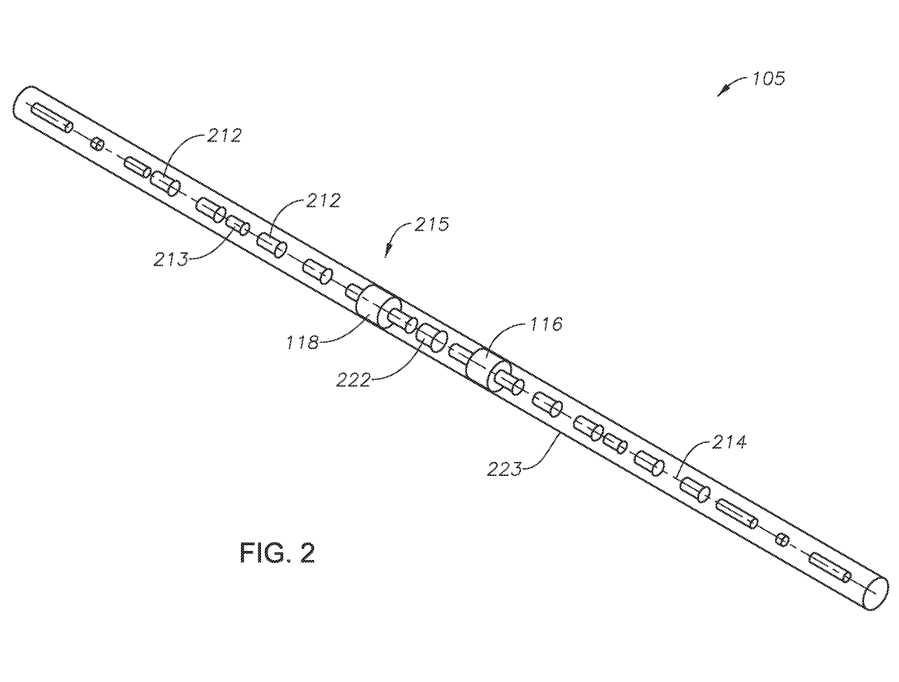

FIG. 2 is a perspective view of a streamer section 215 of the seismic streamer 105 with acoustic positioning sources 116 and the acoustic positioning receivers 118 in accordance with implementations of various techniques described herein. The acoustic positioning source 116 and a positioning source processor 222 may be mounted inside a skin 223 of the streamer section 215 and may use wires in an electrical bundle 214 in the streamer section 215 for receiving power and for communication with the controller 120 (shown in FIG. 1). The positioning source processor 222 may be an electronics module which includes a signal generator and a driver stage (not shown). The positioning source processor 222, and hence the acoustic positioning source 116, may be re-programmable by the controller 120 via the electrical bundle 214.

As illustrated, the acoustic positioning receivers 118 may be dedicated to estimating positions of seismic acquisition equipment, and may be separate from seismic receivers which detect seismic survey signals, as discussed above with respect to FIG. 1. In one implementation, the streamer section 215 may include seismic receivers 212 along with acoustic positioning receivers 118.

The seismic receivers 212 may be connected via the electrical bundle 214 to receiver processors 213. The seismic receivers 212 and the receiver processors 213 may then be connected via the electrical bundle 214 to the controller 120 (shown in FIG. 1). The receiver processors 213 may include electronics modules that perform tasks well known in the art, such as the conversion of analog seismic signals to digital format. In one implementation, the receiver processors 213 may be located in separate modules (not shown) inserted between the streamer sections 215 of the seismic streamer 105.

The acoustic positioning receiver 118 and the receiver processor 213 may be mounted inside the skin 223 of the streamer section 215 and may use wires in the electrical bundle 214 for receiving power and for communication with the controller 120 (shown in FIG. 1). The receiver processor 213 and, hence, acoustic positioning receiver 118, may be re-programmable by the controller 120 via the electrical bundle 214.

### Operation

Various implementations of acoustic positioning systems, including those known to those skilled in the art, may be used to determine the positions of seismic acquisition equipment, such as the relative positions of the acoustic positioning sources 116 and/or the acoustic positioning receivers 118 described above.

In one implementation, the acoustic positioning system may transmit acoustic positioning signals within the frequency range of about 10 kilohertz (kHz) to about 40 kHz. This frequency band may help avoid signal degradation in hostile acoustic environments that occurs when higher ultrasonic frequencies are utilized and decreased signal resolution that occurs when lower frequencies are utilized. The acoustic positioning sources 116 may transmit acoustic positioning signals in the water and the acoustic positioning receivers 118 may receive these transmitted signals. Several acoustic positioning sources 116 may transmit at the same time, but different acoustic positioning sources 116 may transmit different acoustic positioning signals. The different acoustic positioning signals from different acoustic positioning sources 116 may have low cross correlation, so that an acoustic positioning receiver 118 can distinguish between different acoustic positioning signals even if the signals arrive simultaneously.

In another implementation, acoustic positioning systems may employ techniques as discussed in commonly assigned U.S. Pat. No. 5,668,775, which is herein incorporated by reference. In such an implementation, acoustic positioning sources may generate a spread spectrum signal as an orthogonally encoded signal sequence with an unambiguous top in the form of a prominent peak in the signal's autocorrelation function. Cross-correlating the signal received by an acoustic positioning receiver with the orthogonally encoded signal sequence of the transmitted spread spectrum signal may allow the determination of a time difference between the detection of the signal by different acoustic positioning receivers. This time difference, in turn, may allow the determination of the distance between individual acoustic positioning sources and acoustic positioning receivers, based on a known in-line distance between receivers. Multiple acoustic positioning source-receiver combinations may be used to determine a network which then gives the seismic acquisition equipment's geometrical configuration.

In yet another implementation, an acoustic positioning system may use pseudo random noise codes to generate a signal with a wide bandwidth and with the flexibility to generate a number of different acoustic positioning source waveforms with low cross-correlation. Two examples of pseudo random noise sequences may include a Gold sequence and a Kasami sequence. Direct sequence spread spectrum techniques can be used to modulate a single carrier frequency with these pseudo random noise sequences to generate an acoustic positioning signal. Two different modulation techniques may be applied. In the first technique, the pseudo random noise sequence may directly modulate the carrier frequency and accomplish the full band spread. In the second technique, linearly swept chirps may represent the states of the pseudo random noise sequence and the band spread lies mainly in the chirps. This second modulation technique can use smaller pseudo random noise sequences to generate different acoustic positioning source waveforms with smaller cross-correlations. Such an approach may yield better correlation results than using modulation functions with zero cross-correlation, as discussed in U.S. Pat. No. 5,668,775.

In yet another implementation with respect to an acoustic positioning system, the acoustic positioning sources 116 and acoustic positioning receivers 118 may be time synchronized via the controller 120, which may transmit a time synchronization signal to the acoustic positioning sources 116 and acoustic positioning receivers 118. Each acoustic positioning source 116 may emit a unique acoustic positioning signal according to a pre-set triggering schedule of transmissions for that acoustic positioning source 116. At least one acoustic positioning receiver 118 may detect the acoustic positioning signal during a pre-set schedule of listening time windows for that acoustic positioning receiver 118. The travel time between the acoustic positioning source 116 and the acoustic positioning receiver 118 may be estimated based on the time difference between the known triggering time of the acoustic positioning source 116 and the calculated arrival time at the acoustic positioning receiver 118 of the acoustic positioning signal.

The range between the acoustic positioning source 116 and the acoustic positioning receiver 118 can then be calculated, based on knowledge of the sound velocity in the water. The acoustic positioning receiver 118 can listen for acoustic signals from several acoustic positioning sources 116 at the same time and hence determine the range to several acoustic positioning sources 116 in the system simultaneously. The sound velocity in the water may be measured by sound velocity sensors located along the seismic streamers 105. Sound velocity sensors, as known in the art, may measure the speed of sound in water directly, such as by an acoustic time of flight measurement, or may calculate the speed of sound in water indirectly from other sensor-measured parameters, such as conductivity (to determine salinity), temperature, and depth (to determine pressure). However, the velocity sensors can be located elsewhere, such as, for example, in separate modules inserted between the streamer sections 215, in towing apparatus at the front of the streamers 105, in steering apparatus along the streamers 105, or in tail buoys at the rear of the streamers 105. The speed of sound in the water may also be determined by other means known in the art.

In particular, the positioning source processor 222 may receive a time synchronization signal and a triggering schedule from the controller 120. The positioning source processor 222 may use the triggering schedule to indicate to the acoustic positioning source 116 when to transmit acoustic positioning signals to the acoustic positioning receivers 118, relative to the time synchronization signal from the controller 120.

The receiver processor 213 may receive a time synchronization signal and a set of time windows from the controller 120 (see FIG. 1). The receiver processor 213 may use the time window to indicate to the acoustic positioning receiver 118 when to receive acoustic positioning signals from the acoustic positioning source 116, relative to the time synchronization signal from the controller 120.

The positioning source processor 222 may communicate via the electrical bundle 214 with the controller 120 and receive the time synchronization signals and the pre-set triggering schedule from the controller 120. The positioning source processor 222 may use the triggering schedule to determine when an acoustic positioning source 116 should transmit acoustic positioning signals, relative to the reception time of the time synchronization signals received from the controller 120. At the determined time, the signal generator in the positioning source processor 222 may generate the acoustic positioning signal, which is then amplified in the driver stage in the positioning source processor 222. Finally, the positioning source processor 222 may send the amplified acoustic positioning signal via the electrical bundle 214 to the acoustic positioning source 116 for transmission to the acoustic positioning receivers 118.

When one of the acoustic positioning receivers 118 receives the transmitted acoustic positioning signal from one of the acoustic positioning sources 116, the received signal may be sent via the electrical bundle 214 to the receiver processor 213 associated with the acoustic positioning receiver 118. The receiver processor 213 may apply a preliminary signal conditioning to the received signal before further processing. This signal conditioning may include, but is not limited to, pre-amplifying, filtering and digitizing. The digitizing may be applied to that portion of the received signal that arrives at the acoustic positioning receiver 118 during one of its pre-set time windows, thus limiting the received signals to the time windows. Thus, the transmitted acoustic positioning signals may be transmitted according to triggering schedules for each acoustic positioning source 116 and received during time windows for each acoustic positioning receiver 118, all coordinated and time synchronized by the controller 120.

A time window for listening for signals at a particular acoustic positioning receiver 118 may correspond to a travel distance for an acoustic positioning signal transmitted between an acoustic positioning source 116 and that particular acoustic positioning receiver 118. Thus, this coordination of triggering schedules and time windows by the controller 120 may control which acoustic positioning receivers 118 receive signals from which acoustic positioning sources 116. In particular, this coordination may limit the possible acoustic positioning sources 116 from which each of the acoustic positioning receivers 118 can receive signals. For example, each of the acoustic positioning receivers 118 can be limited to receiving signals from one possible acoustic positioning source 116. Further, the possible acoustic positioning sources 116 from which a particular position-determining acoustic positioning receiver 118 can receive signals can change in time under the control of the controller 120.

The digitized received signal may be further processed by the receiver processor 213 associated with the acoustic positioning receiver 118. The receiver processor 213 may confirm reception of the received signal at the acoustic positioning receiver 118 from a particular acoustic positioning source 116. This confirmation of transmission of the received signal from the acoustic positioning source 116 may be accomplished by cross-correlation of the received signal from the acoustic positioning receiver 118 with copies (replicas) of the transmitted acoustic positioning signal from the possible acoustic positioning sources 116. In addition, the receiver processor 213 may determine the arrival time of the received signal at the acoustic positioning receiver 118. This arrival time determination may also be accomplished by the same cross-correlation of received signal with a transmitted signal copy.

Further, since the relative distance between an acoustic positioning source 116 and acoustic positioning receiver 118 varies, the received signal may be shifted, either compressed or expanded, relative to the transmitted acoustic positioning signal, due to Doppler effects. Thus, the receiver processor 213 may determine the appropriate Doppler shift that compensates for these Doppler effects before further processing of the received signal can be undertaken. This determination of Doppler shift may again be accomplished by the same cross-correlation of received signal with transmitted signal copy, as explained above. Thus, these cross-correlations may be calculated once for each possible combination of received signal, transmitted signal copy, and Doppler shift to determine the appropriate Doppler compensation for the received signal, the identity of the acoustic positioning source 116 of the received signal, and the arrival time of the received signal.

Once the receiver processor 213 confirms the transmission of the received signal from a particular acoustic positioning source 116 to the position-determining acoustic positioning receiver 118, the receiver processor 213 may employ the triggering schedule of that acoustic positioning source 116 to acquire the transmission time for the received signal. Then, the receiver processor 213 can calculate the difference between the transmission and arrival times of the received signal. This time difference yields the travel time between this particular pair of acoustic positioning source 116 and acoustic positioning receiver 118 at this particular time. With knowledge of this travel time and the sound velocity in the water, the travel distance between the acoustic positioning source 116 and the acoustic positioning receiver 118 may be calculated. In one implementation, this calculation may be performed in the controller 120. Accordingly, the travel time may be sent via the electrical bundle 214 from the receiver processor 213 to the controller 120.

In addition, the receiver processor 213 may perform the cross-correlations of the received signal with copies of possible acoustic positioning signals in an iterative scheme. For a particular received signal at a particular acoustic positioning receiver 118, the receiver processor 213 may determine a set of possible acoustic positioning sources 116 that could be the source of that received signal. This determination may be accomplished, for example, by comparing the triggering schedules of the acoustic positioning sources 116 with the time window of the position-determining acoustic positioning receiver 118 during which the received signal arrived. This comparison may be done by either the receiver processor 213 after receiving the necessary information (triggering schedules and time windows) from the controller 120, or by the controller 120 before sending the result (possible acoustic positioning sources 116) to the receiver processor 213.

The iterative scheme may begin by iteratively checking each of the set of possible acoustic positioning sources 116 determined above. The receiver processor 213 may select one acoustic positioning source 116 from the set of possible acoustic positioning sources 116. The receiver processor 213 may supply a copy of the particular acoustic positioning signal for the selected acoustic positioning source 116. Copies of the different acoustic positioning signals may be stored in the receiver processor 213. In one implementation, the copies of the acoustic positioning signals may be generated by the receiver processor 213.

The receiver processor 213 may determine a set of possible Doppler shifts to compensate the received signal for the Doppler effects that might be anticipated due to survey conditions, such as the size and direction of currents in the vicinity of the acoustic positioning source 116 and acoustic positioning receiver 118 being investigated. Doppler compensation may be accomplished by removing data samples from or adding data samples to the received signal, according to whether the received signal is being compressed or expanded, respectively, by Doppler effects. The iterative scheme may then iteratively check each of these possible Doppler shifts. The receiver processor 213 may select one Doppler shift from this set of possible Doppler shifts and apply this Doppler shift to the received signal.

The receiver processor 213 may calculate the cross-correlation of the Doppler-compensated received signal with the copy of the acoustic positioning signal for the acoustic positioning source 116 being checked. The receiver processor 213 may calculate the envelope of the cross-correlation, and then may determine the first peak in the envelope which may have a correlation signal-to-noise ratio that may be detectable above the correlation noise. The receiver processor 213 may apply a peak detection algorithm to determine the first peak or apply any other method well known in the art. The receiver processor 213 may calculate the correlation signal-to-noise and time for this detected correlation peak, and may save both peak correlation signal-to-noise ratio and peak time in memory for later retrieval. The term correlation signal-to-noise ratio may be used here to mean the ratio of the signal in the correlation envelope to the noise in the correlation envelope, as measured at the first detectable peak in the correlation envelope.

The iterative scheme may check each of the remaining Doppler shifts in the set of possible Doppler shifts. The receiver processor 213 may repeat the cross-correlations described above for the remaining possible Doppler shifts. The Doppler shift that yields the best of the saved correlation peak signal-to-noise ratios for the received signal may be designated as the Doppler shift compensation for that particular acoustic positioning source 116 and position-determining acoustic positioning receiver 118 combination. The saved peak time of the detected correlation peak for the designated Doppler compensation may be designated as the estimated arrival time for the received signal from that acoustic positioning source 116.

The iterative scheme may check each of the remaining acoustic positioning sources 116 in the set of possible acoustic positioning sources 116. The receiver processor 213 may repeat the above implementation for finding the Doppler compensation and estimated arrival time, described in the previous paragraph, for the remaining possible acoustic positioning sources 116. The acoustic positioning signals from different acoustic positioning sources 116 may be used in conjunction with low cross-correlations. Thus, the calculated cross-correlations of the received signal with the copies of the acoustic positioning signals from different acoustic positioning sources 116 may be low for the acoustic positioning sources 116, except for the actual acoustic positioning source 116 of the received signal. The first location of a correlation peak with sufficient correlation signal-to-noise ratio to be significantly detectable within the time window of the position-determining acoustic positioning receiver 118 may be used to determine the arrival time of the received signal from the source acoustic positioning source 116.

The receiver processors 213 may repeat the above-described iterative scheme for received signals and their corresponding acoustic positioning receivers 118 to identify the acoustic positioning sources 116 of the received signals and to estimate the corresponding travel times for the received signals.

Then, the receiver processors 213 can determine travel times between the pairs of acoustic positioning sources 116 and acoustic positioning receivers 118 determined by the previously-described iterative cross-correlation scheme. The receiver processor 213 may calculate the time difference between the start time and the arrival time of the corresponding received signal. The receiver processor 213 may have information of the start time of the received signal from the triggering schedule for the source acoustic positioning source 116, as confirmed by the cross-correlation results. The receiver processor 213 may have information of the arrival time of the received signal from the detected first correlation peak of the received signal, as determined from the cross-correlation results. The receiver processors 213 may repeat this calculation for the received signals to yield the travel times between pairs of acoustic positioning sources 116 and acoustic positioning receivers 118.

The receiver processors 213 may send the travel times to the controller 120. In one implementation, the travel times may be measured and sent as numbers of clock periods instead of actual time. Temperature-compensated quartz crystal oscillators could be used as clocks in the receiver processors 213 to improve accuracy and stability while minimizing size and power consumption. The controller 120 may use these travel times, multiplied by the local sound velocity in the water, to calculate the travel distances between the acoustic positioning sources 116 and the acoustic positioning receivers 118. The local sound velocity in water may be estimated, measured by sound velocity sensors located along the seismic streamers, or obtained by any other means known in the art.

The controller 120 may combine the travel distances between the pairs of acoustic positioning sources 116 and acoustic positioning receivers 118 into a trilateration network representation of the acoustic positioning sources 116 and acoustic positioning receivers 118 in the towed marine seismic streamers 105. A trilateration network may be a two-dimensional model using triangular-shaped elements to represent the known relative distances between the unknown acoustic positioning source 116 and position-determining acoustic positioning receiver 118 positions (nodes). Standard mathematical techniques are known in the art for solving for the nodes in a trilateration network. Thus, the controller 120 may determine the relative positions of the towed marine seismic streamers 105 from the calculated positions of the acoustic positioning sources 116 and acoustic positioning receivers 118 on the streamers 105.

### Reflected Positioning Signal Identification

As described above with respect to FIGS. 1 and 2, various implementations of the acoustic positioning system may be used to estimate the positions of seismic acquisition equipment used in a seismic survey. For example, the relative positions of the acoustic positioning sources 116 and/or the acoustic positioning receivers 118 may be determined using acoustic positioning signals. These relative positions may, in turn, be used to determine the relative positions of the seismic streamers 105, including the depth of the seismic streamers 105.

In one implementation, in estimating the positions of the seismic acquisition equipment, the one or more acoustic positioning signals emitted by the acoustic positioning sources 116 and detected by the acoustic positioning receivers 118 may travel via a direct arrival or a reflected arrival.

An acoustic positioning signal traveling via direct arrival, hereinafter referred to as a direct positioning signal, may travel along a path of shortest travel time in the water column 106 without being influenced by reflection from the water surface 102 or the sea floor 108. An acoustic positioning signal traveling via reflected arrival, hereinafter referred to as a reflected positioning signal, may travel on a path having a longer travel distance than the direct positioning signal. Such reflected positioning signals may reflect from a boundary interface, like the water surface 102 or the sea floor 108, after being emitted from the acoustic positioning source 116. In such an implementation, reflected positioning signals may be subject to a travel time delay relative to the direct positioning signals.

Accordingly, using the reflected positioning signals rather than, or in addition to, the direct positioning signals when determining the positions of the acoustic positioning sources 116 and/or the acoustic positioning receivers 118 may lead to inaccurate estimations of the positions of seismic acquisition equipment. Conversely, correction and/or removal of the reflected positioning signals captured by acoustic positioning receivers 118 may improve the accuracy of these estimated positions of the seismic acquisition equipment.

### Method

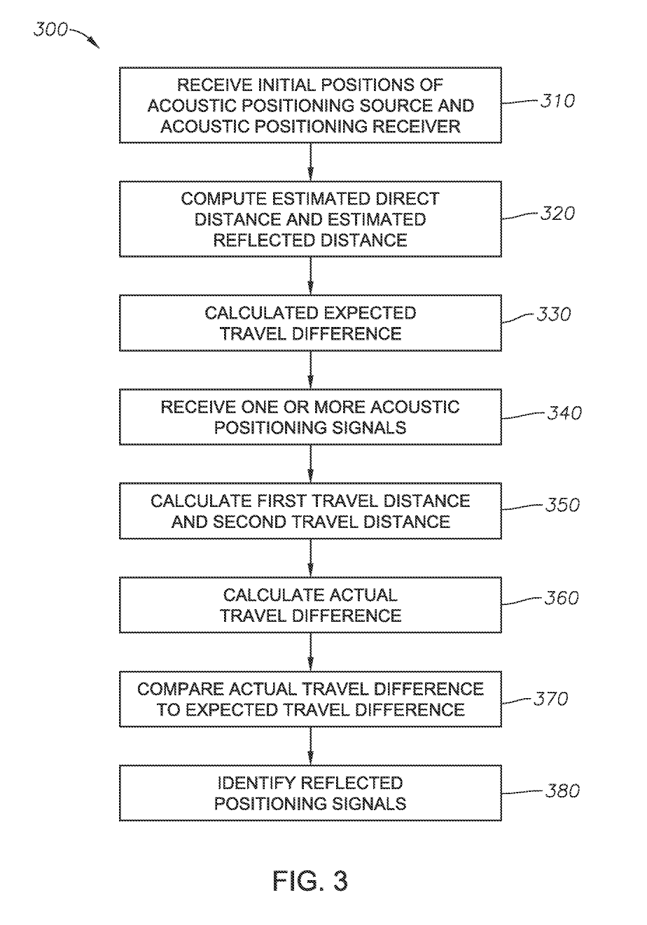

FIG. 3 illustrates a flow diagram of a method 300 for identifying a reflected positioning signal transmitted by an acoustic positioning receiver 118 and detected by an acoustic positioning source 116 in accordance with implementations of various techniques described herein. In one implementation, method 300 may be performed by a computer application. In a further implementation, method 300 may be performed by controller 120 (shown in FIG. 1). It should be understood that while method 300 indicates a particular order of execution of operations, in some implementations, certain portions of the operations might be executed in a different order.

In one implementation, method 300 may be repeated for different pairs of acoustic positioning receivers 118 and acoustic positioning sources 116 of the acoustic positioning system.

At block 310, the computer application may receive initial positions of the acoustic positioning source 116 and the acoustic positioning receiver 118. In one implementation, the initial positions may be an expected distance (or range) between the acoustic positioning source 116 and the acoustic positioning receiver 118. In another implementation, the initial positions may be the presumed geographical positions of the acoustic positioning source 116 and the acoustic positioning receiver 118. The initial positions may be received from a model stored in memory or any other implementation known to those skilled in the art.

The acoustic positioning source 116 and the acoustic positioning receiver 118 may be positioned on the same seismic streamer 105 or on different seismic streamers 105, i.e., may be used for inline ranging or crossline, i.e., inter-streamer, ranging, as described above. In another implementation, the initial positions may include a tow depth of these one or more seismic streamers 105.

At block 320, the computer application may compute an estimated direct distance and an estimated reflected distance between the acoustic positioning source 116 and the acoustic positioning receiver 118 using the initial positions. A direct distance may be a travel distance of a direct positioning signal transmitted from the acoustic positioning source 116 to the acoustic positioning receiver 118. A reflected distance may be a travel distance of a reflected positioning signal transmitted from the acoustic positioning source 116 to the acoustic positioning receiver 118.

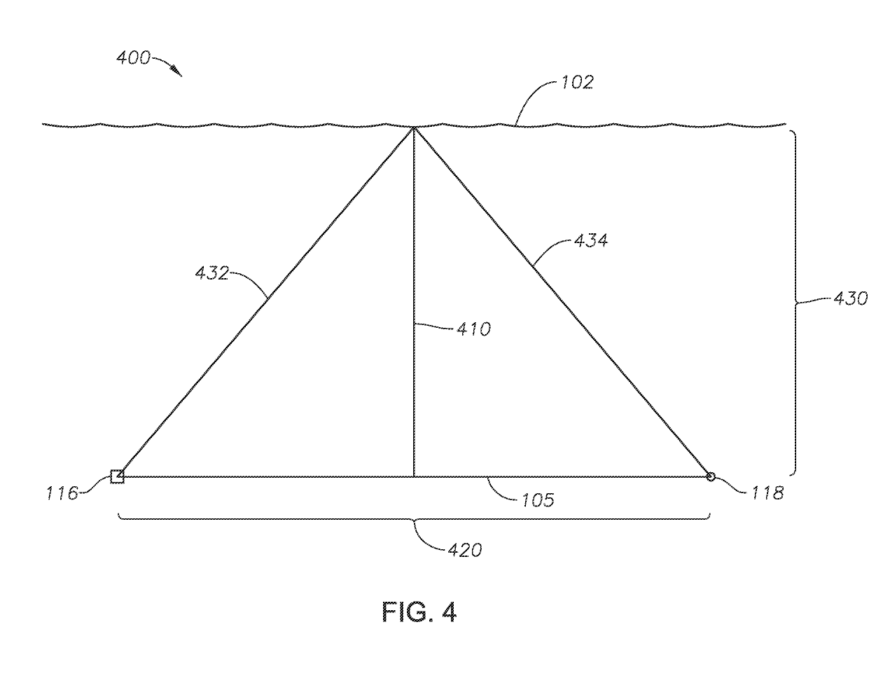

The estimated direct distance and the estimated reflected distance may be geometrically derived using the initial positions from above, which may include a tow depth of at least one seismic streamer 105, a tow depth of the acoustic positioning source 116, a tow depth of the acoustic positioning receiver 118, and/or knowledge of one or more boundary interfaces. For example, FIG. 4 illustrates a travel distance model 400 for the acoustic positioning source 116 and the acoustic positioning receiver 118. As illustrated, the travel distance model 400 may show positions of the seismic streamer 105, the acoustic positioning source 116, and the acoustic positioning receiver 118 with respect to a water surface 102. In particular, the seismic streamer 105 may have a tow depth 410, and may contain the acoustic positioning source 116 and the acoustic positioning receiver 118. The acoustic positioning source 116 and the acoustic positioning receiver 118 may also have tow depths equal to tow depth 410. In one implementation, the travel distance model 400 may include a slanted seismic streamer having a changing tow depth. In such an implementation, the tow depth of the acoustic positioning source 116 and the tow depth of the acoustic positioning receiver 118 may not be equal.

In another implementation, the estimated direct distance 420 may be considered to be the same amount as the range between the acoustic positioning source 116 and the acoustic positioning receiver 118. Further, the estimated reflected distance 430 may be determined using geometric principles on the triangular travel distance model 400. For example, the estimated reflected distance 430 may be a combination of partial distance 432 and partial distance 434, where the partial distance 432 and partial distance 434 may be derived using the Pythagorean Theorem. The partial distance 432 may be a travel distance of an acoustic positioning signal transmitted from the acoustic positioning source 116 to the water surface 102, whereas the partial distance 434 may be a travel distance of the acoustic positioning signal reflected from the water surface 102 to the acoustic positioning receiver 118.

In yet another implementation, the estimated direct distance 420 and the estimated reflected distance 430 may be approximated based on a historical trend of previous direct positioning signals and reflected positioning signals emitted by the acoustic positioning source 116 and captured by the acoustic positioning receiver 118, such as through an acoustic positioning system described above with respect to FIG. 1-2. In such an implementation, the estimated direct distance 420 may be derived based on previous direct positioning signals, and the estimated reflected distance 430 may be derived based on previous reflected positioning signals.

At block 330, the computer application may calculate an expected travel difference between the acoustic positioning source 116 and the acoustic positioning receiver 118. The expected travel difference may be determined by subtracting the estimated direct distance 420 from the estimated reflected distance 430.

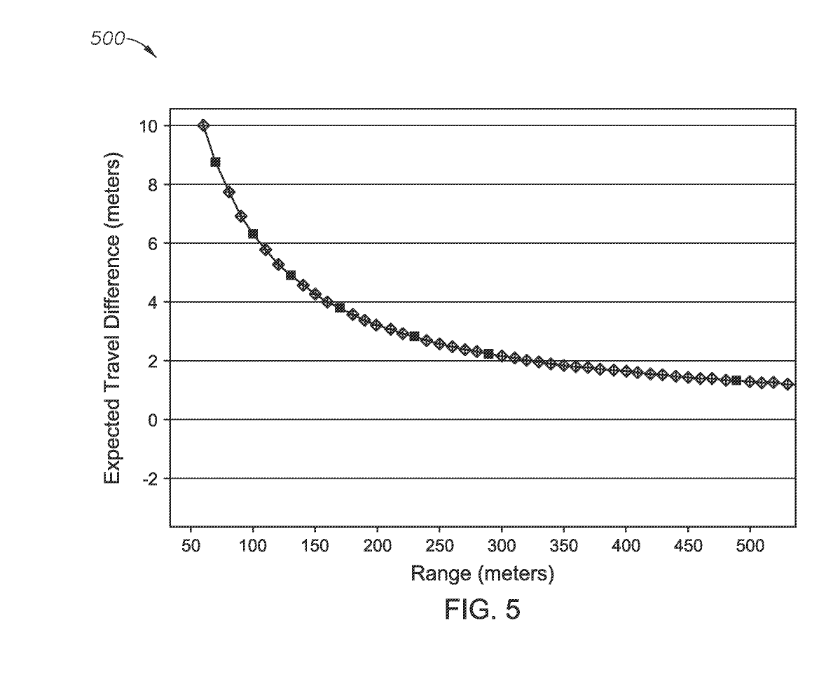

The expected travel difference may be larger for pairs of acoustic positioning sources and acoustic positioning receivers that are separated by smaller ranges. For example, FIG. 5 illustrates a graphical representation 500 of the expected travel difference for pairs of acoustic positioning sources 116 and acoustic positioning receivers 118 in accordance with implementations of various techniques described herein. For the graphical representation 500, the pairs of acoustic positioning sources 116 and acoustic positioning receivers 118 may be disposed on the same seismic streamer 105 with a tow depth of 18 meters, and the expected travel differences may be derived based on positioning signals reflected from the water surface 102 (see FIG. 1).

In such an implementation, the x-axis of the graphical representation 500 may represent the range for pairs of acoustic positioning sources 116 and acoustic positioning receivers 118, based on the initial positions from block 310. The y-axis may represent the expected travel difference for pairs of acoustic positioning sources 116 and acoustic positioning receivers 118.

As can be seen from the graphical representation 500, as the range between the acoustic positioning source 116 and acoustic positioning receiver 118 increases, the expected travel difference may decrease. Accordingly, inaccuracies of the acoustic positioning system due to reflected positioning signals may be lower in longer ranges. Similarly, though not shown in FIG. 5, the expected travel difference may increase as the seismic streamer 105 is positioned farther away from a boundary interface, such as the sea floor 108.

At block 340, the computer application may receive one or more acoustic positioning signals from the acoustic positioning receiver 118. In particular, the one or more acoustic positioning signals may have been emitted by the acoustic positioning source 116 and captured by the acoustic positioning receiver 118, such as through an acoustic positioning system described above with respect to FIG. 1-2. The acoustic positioning receiver 118 may transfer the one or more acoustic positioning signals to the controller 120 (shown in FIG. 1).

In one implementation, the computer application may receive at least a first acoustic positioning signal and a second acoustic positioning signal from the acoustic positioning receiver 118. In such an implementation, the first acoustic positioning signal may have been emitted before the second acoustic positioning signal, or vice versa. In another implementation, more than two acoustic positioning signals may be received from the acoustic positioning receiver 118.

In yet another implementation, the computer application may receive an acoustic positioning signal that may have traveled in at least two separate paths before being captured by the acoustic positioning receiver 118. In such an implementation, the acoustic positioning system used to emit and capture the acoustic positioning signal may also cross-correlate the signal, producing at least one peak of the acoustic positioning signal which may correspond to the acoustic positioning source 116. In particular, the acoustic positioning system may cross-correlate the acoustic positioning signal over a time window, producing a first peak and a second peak.

At block 350, the computer application may calculate a first travel distance and a second travel distance for the one or more acoustic positioning signals. In one implementation, the computer application may calculate the first travel distance for the first acoustic positioning signal and the second travel distance for the second acoustic positioning signal. In another implementation, the computer application may calculate the first travel distance for the first peak of an acoustic positioning signal and the second travel distance for the second peak of the acoustic positioning signal.

The calculation may be performed in near real-time soon after receiving the one or more acoustic positioning signals. In another implementation, the calculation may be performed at a time and/or date after receiving the one or more acoustic positioning signals, where the signals may be retrieved from memory. In yet another implementation, more than two travel distances may be calculated if more than two acoustic positioning signals are received from the acoustic positioning receiver 118.

In such an implementation, the acoustic positioning system referenced with respect to block 340 may determine a first travel time for the first acoustic positioning signal and a second travel time for the second acoustic positioning signal. Similarly, in another implementation, the acoustic positioning system may determine a first travel time for the first peak and a second travel time for the second peak. Accordingly, in either implementation, using a sound velocity of the water column 106 (shown in FIG. 1) proximate to the acoustic positioning receiver 118, the first travel distance may be derived from the first travel time, and the second travel distance may be derived from the second travel time.

At block 360, the computer application may calculate an actual travel difference between the acoustic positioning source 116 and the acoustic positioning receiver 118. The actual travel difference may be determined by subtracting the first travel distance from the second travel distance. In another implementation, the actual travel difference may be determined by subtracting the first travel time from the second travel time, and multiplying the difference by the sound velocity mentioned above. Accordingly, in calculating the actual travel difference, the subtraction may be carried out in either the time domain or the distance domain. In yet another implementation, if more than two travel distances were calculated with respect to block 350, then more than one actual travel difference may be calculated by using acoustic positioning signals transmitted adjacently in time.

The actual travel difference may be a positive value or a negative value, depending on the sizes of the first travel distance and the second travel distance.

At block 370, the computer application may compare the actual travel difference to the expected travel difference. In one implementation, the comparison may be made if the expected travel difference is greater than at least a precision of the acoustic positioning system referenced with respect to block 350. The precision of the acoustic positioning system may be based on an exactness and/or a smallest increment of the one or more acoustic positioning signals emitted and captured by the system. For example, the acoustic positioning system may capture an acoustic positioning signal, whose travel distance may be measured and calculated within a precision of two meters. If the expected travel difference mentioned above is less than the precision of the acoustic positioning system, the method 300 may end.

In implementations involving different pairs of acoustic positioning receivers 118 and acoustic positioning sources 116, a filter may be used to remove expected travel differences that may be less than the precision of the acoustic positioning system, such that those filtered expected travel differences may not be compared to actual travel differences. In one implementation, the filtered expected travel differences may correspond to pairs of acoustic positioning receivers 118 and acoustic positioning sources 116 having longer ranges. For example, looking at FIG. 5, if the precision of the acoustic positioning system is about two meters, then the pairs of acoustic positioning receivers and acoustic positioning sources with ranges above roughly 300 meters may have their expected travel differences filtered.

In yet another implementation, the comparison may be made if the expected travel difference is greater than a factor of the precision of the acoustic positioning system. For example, if the precision is about one centimeter, then the comparison may be made if the expected travel difference is greater than about one meter.

At block 380, the computer application may identify reflected positioning signals, based on the above comparison. In one implementation, the first acoustic positioning signal and/or the second acoustic positioning signal may be identified as a reflected positioning signal if the actual travel difference is within a range of the expected travel difference. In another implementation, the first peak and/or the second peak may be identified as a reflected positioning signal if the actual travel difference is within a range of the expected travel difference. In either implementation, the range may be defined by predetermined percentages of the expected travel difference.

In particular, if the actual travel difference is a positive value, then the second acoustic positioning signal, or the second peak, may be a reflected positioning signal if the actual travel difference is within positive predetermined percentages of the expected travel difference. In such a case, the first acoustic positioning signal, or the first peak, may be a direct positioning signal. In one example, if the actual travel difference is a positive value, then the second acoustic positioning signal, or the second peak, may be a reflected positioning signal if the actual travel difference is greater than about 60% of the expected travel difference and less than about 150% of the expected travel difference. In such an implementation, the higher percentage, e.g., 150%, may be used to avoid the incorporation of extraneous spikes from the acoustic positioning source 116.

Further, if the actual travel difference is a negative value, then the first acoustic positioning signal, or the first peak, may be a reflected positioning signal if the actual travel difference is within negative predetermined percentages of the expected travel difference. In such a case, the second acoustic positioning signal, or the second peak, may be a direct positioning signal. For example, if the actual travel difference is a negative value, then the first acoustic positioning signal, or the first peak, may be a reflected positioning signal if the actual travel difference is less than about −60% of the expected travel difference and greater than about −150% of the expected travel difference. In such an implementation, the lower percentage, e.g., −150%, may be used to avoid the incorporation of extraneous spikes from the acoustic positioning source 116.

The predetermined percentages may be based on the acoustic positioning system referenced with respect to block 340, historical data of previous acoustic positioning signals, statistical observation and the like. In another implementation, after identifying acoustic positioning signals as a reflected positioning signal, then previous and/or subsequent acoustic positioning signals with similar travel distances to the identified acoustic positioning signals may also be reflected positioning signals. Further, the same may be true for acoustic positioning signals identified as direct positioning signals. In yet another implementation, the same may be true for previous and/or subsequent peaks for an acoustic positioning signal.

### Previously Solved Dataset

In yet another implementation, the identified direct and reflected positioning signals may be verified by comparing the signals to a previously solved dataset for the acoustic positioning source 116 and acoustic positioning receiver 118. The previously solved dataset may include solved travel distances for acoustic positioning signals previously captured by the acoustic positioning receiver 118. In one implementation, the previously solved dataset may have been produced using a different acoustic positioning system from the system reference with respect to block 340. In another implementation, the previously solved dataset may have been based on multiple pairs of acoustic positioning sources 116 and acoustic positioning receivers 118 having multiple ranges. In such an implementation, the previously solved dataset may have been based on hundreds of thousands of ranges.

In one example, the identified direct and reflected positioning signals may be verified by determining if the solved travel distances of the previously solved dataset are greater than the travel distances of the direct positioning signals and less than travel distances of the reflected positioning signals. If so, then the identification of the direct and reflected positioning signals from block 380 may be accurate.

In sum, the implementations for identifying a reflected positioning signal, described above with respect to FIGS. 1-5, may check if acoustic positioning signals for an acoustic positioning receiver and an acoustic positioning source fit an expected model of reflected positioning signals within a predetermined percentage.

Once a reflected positioning signal is identified, the reflected positioning signal can be corrected in or removed from a data record captured by an acoustic positioning receiver. In one implementation, correcting the reflected positioning signal may include reducing the travel distance of the reflected positioning signal by the expected travel difference referenced in block 330. The reduced travel distance may then be a computed measurement and may incorporate both the expected travel difference as well as the actual travel difference. Accordingly, this reduced travel distance may be given a lower weight when using the reduced travel distance to estimate positions of seismic acquisition equipment, as discussed above with respect to FIGS. 1-2. Such corrections of the reflected positioning signal may also be used for scenarios where the data record has a high number of reflected positioning signals with few direct positioning signals.

The data record with the corrected or removed reflected positioning signals may be used to produce more accurate estimates of positions of the seismic acquisition equipment than a data record with uncorrected or present reflected positioning signals. Further, the implementations above may take into account multiple acoustic positioning signals when identifying a reflected positioning signal, which may similarly produce more accurate estimates.

### Computing Systems

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc., that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

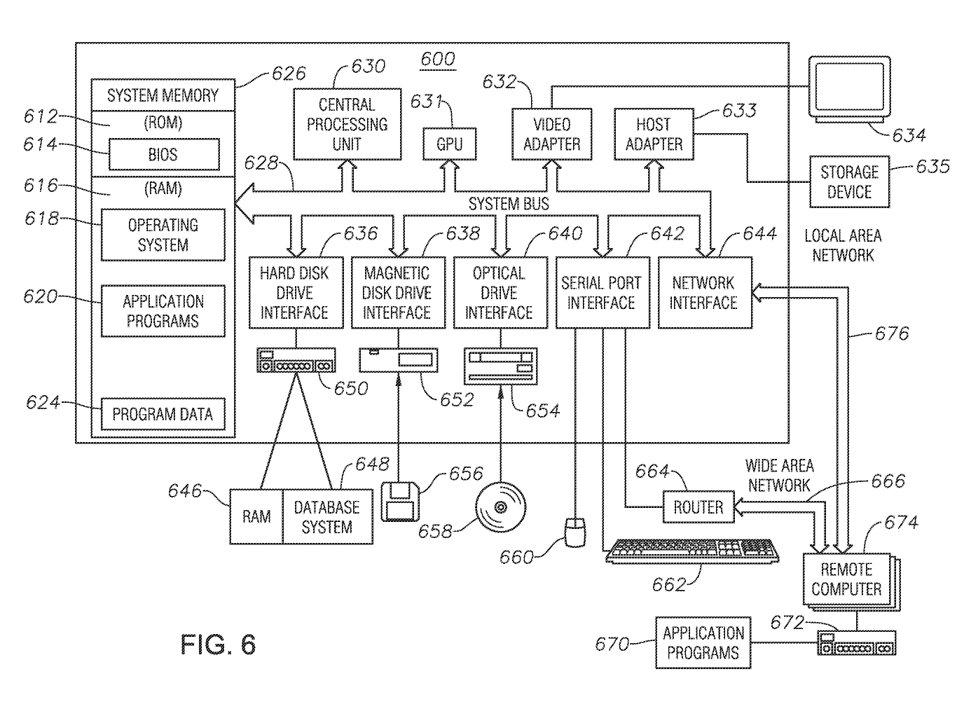

FIG. 6 illustrates a schematic diagram of a computing system 600 in which the various technologies described herein may be incorporated and practiced. Although the computing system 600 may be a conventional desktop or a server computer, as described above, other computer system configurations may be used.

The computing system 600 may include a central processing unit (CPU) 630, a system memory 626, a graphics processing unit (GPU) 631 and a system bus 628 that couples various system components including the system memory 626 to the CPU 630. Although one CPU is illustrated in FIG. 6, it should be understood that in some implementations the computing system 600 may include more than one CPU. The GPU 631 may be a microprocessor specifically designed to manipulate and implement computer graphics. The CPU 630 may offload work to the GPU 631. The GPU 631 may have its own graphics memory, and/or may have access to a portion of the system memory 626. As with the CPU 630, the GPU 631 may include one or more processing units, and the processing units may include one or more cores. The system bus 628 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 626 may include a read-only memory (ROM) 612 and a random access memory (RAM) 646. A basic input/output system (BIOS) 614, containing the basic routines that help transfer information between elements within the computing system 600, such as during start-up, may be stored in the ROM 612.

The computing system 600 may further include a hard disk drive 650 for reading from and writing to a hard disk, a magnetic disk drive 652 for reading from and writing to a removable magnetic disk 656, and an optical disk drive 654 for reading from and writing to a removable optical disk 658, such as a CD ROM or other optical media. The hard disk drive 650, the magnetic disk drive 652 and the optical disk drive 654 may be connected to the system bus 628 by a hard disk drive interface 656, a magnetic disk drive interface 658, and an optical drive interface 650, respectively. The drives and their associated computer-readable media may provide nonvolatile storage of computer-readable instructions, data structures, program modules and other data for the computing system 600.

Although the computing system 600 is described herein as having a hard disk, a removable magnetic disk 656 and a removable optical disk 658, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 600 may also include a host adapter 633 that connects to a storage device 635 via a small computer system interface (SCSI) bus, a Fiber Channel bus, an eSATA bus or using any other applicable computer bus interface. Combinations of any of the above may also be included within the scope of computer readable media.

A number of program modules may be stored on the hard disk 650, magnetic disk 656, optical disk 658, ROM 612 or RAM 616, including an operating system 618, one or more application programs 620, program data 624 and a database system 648. The application programs 620 may include various mobile applications (“apps”) and other applications configured to perform various methods and techniques described herein. The operating system 618 may be any suitable operating system that may control the operation of a networked personal or server computer, such as Windows® XP, Mac OS® X, Unix-variants (e.g., Linux® and BSD®), and the like.

A user may enter commands and information into the computing system 600 through input devices such as a keyboard 662 and pointing device 660. Other input devices may include a microphone, joystick, game pad, satellite dish, scanner or the like. These and other input devices may be connected to the CPU 630 through a serial port interface 642 coupled to system bus 628, but may be connected by other interfaces, such as a parallel port, game port or a universal serial bus (USB). A monitor 634 or other type of display device may also be connected to system bus 628 via an interface, such as a video adapter 632. In addition to the monitor 634, the computing system 600 may further include other peripheral output devices such as speakers and printers.

Further, the computing system 600 may operate in a networked environment using logical connections to one or more remote computers 674. The logical connections may be any connection that is commonplace in offices, enterprise-wide computer networks, intranets, and the Internet, such as local area network (LAN) 656 and a wide area network (WAN) 666. The remote computers 674 may be another a computer, a server computer, a router, a network PC, a peer device or other common network node, and may include many of the elements describes above relative to the computing system 600. The remote computers 674 may also each include application programs 670 similar to that of the computer action function.

When using a LAN networking environment, the computing system 600 may be connected to the local network 676 through a network interface or adapter 644. When used in a WAN networking environment, the computing system 600 may include a router 664, wireless router or other means for establishing communication over a wide area network 666, such as the Internet. The router 664, which may be internal or external, may be connected to the system bus 628 via the serial port interface 652. In a networked environment, program modules depicted relative to the computing system 600, or portions thereof, may be stored in a remote memory storage device 672. It will be appreciated that the network connections shown are merely examples and other means of establishing a communications link between the computers may be used.

The network interface 644 may also utilize remote access technologies (e.g., Remote Access Service (RAS), Virtual Private Networking (VPN), Secure Socket Layer (SSL), Layer 2 Tunneling (L2T) or any other suitable protocol). These remote access technologies may be implemented in connection with the remote computers 674.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device and at least one output device. One or more programs that may implement or utilize the various technologies described herein may use an application programming interface (API), reusable controls and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

The system computer 600 may be located at a data center remote from the survey region. The system computer 600 may be in communication with the receivers (either directly or via a recording unit, not shown), to receive signals indicative of the reflected seismic energy. These signals, after conventional formatting and other initial processing, may be stored by the system computer 600 as digital data in the disk storage for subsequent retrieval and processing in the manner described above. In one implementation, these signals and data may be sent to the system computer 600 directly from sensors, such as geophones, hydrophones and the like. When receiving data directly from the sensors, the system computer 600 may be described as part of an in-field data processing system. In another implementation, the system computer 600 may process seismic data already stored in the disk storage. When processing data stored in the disk storage, the system computer 600 may be described as part of a remote data processing center, separate from data acquisition. The system computer 600 may be configured to process data as part of the in-field data processing system, the remote data processing system or a combination thereof.

Those with skill in the art will appreciate that any of the listed architectures, features or standards discussed above with respect to the example computing system 600 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is limited to the specific features or acts described above. Rather, the specific features and acts described above are disclosed as example forms of implementing the claims.

What is claimed is:

1. A method, comprising:
receiving initial positions of an acoustic positioning source and an acoustic positioning receiver of an acoustic positioning system in a seismic spread;
calculating an expected travel difference between the acoustic positioning source and the acoustic positioning receiver;
receiving one or more acoustic positioning signals from the acoustic positioning receiver;
calculating an actual travel difference between the acoustic positioning source and the acoustic positioning receiver based on the one or more acoustic positioning signals;
comparing the actual travel difference to the expected travel difference; and
identifying whether the one or more acoustic positioning signals are reflected positioning signals based on the comparison.

2. The method of claim 1, wherein calculating the expected travel difference comprises:
estimating a direct distance and a reflected distance between the acoustic positioning source and the acoustic positioning receiver using the initial positions; and
subtracting the estimated direct distance from the estimated reflected distance.

3. The method of claim 2, wherein the direct distance is a travel distance of an acoustic positioning signal transmitted from the acoustic positioning source to the acoustic positioning receiver, wherein the acoustic positioning signal travels via a direct arrival.

4. The method of claim 2, wherein the reflected distance is a travel distance of an acoustic positioning signal transmitted from the acoustic positioning source to the acoustic positioning receiver, wherein the acoustic positioning signal travels via a reflected arrival.

5. The method of claim 1, wherein the one or more acoustic positioning signals were transmitted by the acoustic positioning source to the acoustic positioning receiver.

6. The method of claim 1, further comprising:
receiving a first acoustic positioning signal and a second acoustic positioning signal from the acoustic positioning receiver; and
identifying whether the first acoustic positioning signal, the second acoustic positioning signal, or both are reflected positioning signals based on the comparison.

7. The method of claim 6, wherein calculating the actual travel difference comprises:
calculating a first travel distance for the first acoustic positioning signal and a second travel distance for the second acoustic positioning signal between the acoustic positioning source and the acoustic positioning receiver; and
subtracting the first travel distance from the second travel distance.

8. The method of claim 7, further comprising:
calculating the first travel distance based on a travel time of the first acoustic positioning signal and a sound velocity of a water column proximate to the acoustic positioning receiver; and
calculating the second travel distance based on a travel time of the second acoustic positioning signal and the sound velocity of the water column proximate to the acoustic positioning receiver.

9. The method of claim 6, wherein identifying whether the first acoustic positioning signal, the second acoustic positioning signal, or both are reflected positioning signals comprises:
if the actual travel difference is a positive value, identifying the second acoustic positioning signal as a reflected positioning signal if the actual travel difference is within positive predetermined percentages of the expected travel difference; and
identifying the first acoustic positioning signal as a direct positioning signal.

10. The method of claim 6, wherein identifying whether the first acoustic positioning signal, the second acoustic positioning signal, or both are reflected positioning signals comprises:
if the actual travel difference is a negative value, identifying the first acoustic positioning signal as a reflected positioning signal if the actual travel difference is within negative predetermined percentages of the expected travel difference; and
identifying the second acoustic positioning signal as a direct positioning signal.

11. The method of claim 1, further comprising verifying the identified reflected positioning signals based on a previously solved dataset for the acoustic positioning source and the acoustic positioning receiver.

12. The method of claim 1, further comprising:
cross-correlating a first acoustic positioning signal over a time window;
producing a first peak and a second peak corresponding to the first acoustic positioning signal;
comparing an actual travel difference to an expected travel difference for the first peak and the second peak; and
based on the comparison, identifying whether the first peak, the second peak, or both are reflected positioning signals.

13. The method of claim 1, further comprising:
removing or correcting the identified reflected positioning signals from a data record formed using the acoustic positioning source and the acoustic positioning receiver; and
estimating positions of seismic acquisition equipment in the seismic spread based on the data record.

14. A non-transitory computer-readable medium having stored thereon computer-executable instructions which, when executed by a computer, cause the computer to:
receive initial positions of an acoustic positioning source and an acoustic positioning receiver of an acoustic positioning system in a seismic spread;
calculate an expected travel difference between the acoustic positioning source and the acoustic positioning receiver;
receive one or more acoustic positioning signals from the acoustic positioning receiver;
calculate an actual travel difference between the acoustic positioning source and acoustic positioning receiver based on the one or more acoustic positioning signals;
compare the actual travel difference to the expected travel difference; and
based on the comparison, identify whether the one or more acoustic positioning signals are reflected positioning signals.

15. The non-transitory computer-readable medium of claim 14, further comprising computer-executable instructions which, when executed by a computer, cause the computer to:
receive a first acoustic positioning signal and a second acoustic positioning signal from the acoustic positioning receiver; and
identify whether the first acoustic positioning signal, the second acoustic positioning signal, or both are reflected positioning signals based on the comparison.

16. The non-transitory computer-readable medium of claim 15, wherein the computer-executable instructions which, when executed by a computer, cause the computer to calculate the actual travel difference further comprise computer-executable instructions which, when executed by a computer, cause the computer to:
calculate a first travel distance for the first acoustic positioning signal and a second travel distance for the second acoustic positioning signal between the acoustic positioning source and the acoustic positioning receiver; and
subtract the first travel distance from the second travel distance.

17. The non-transitory computer-readable medium of claim 15, wherein the computer-executable instructions which, when executed by a computer, cause the computer to identify whether the first acoustic positioning signal, the second acoustic positioning signal, or both are reflected positioning signals further comprise computer-executable instructions which, when executed by a computer, cause the computer to:
if the actual travel difference is a positive value, identify the second acoustic positioning signal as a reflected positioning signal if the actual travel difference is within positive predetermined percentages of the expected travel difference; and
identify the first acoustic positioning signal as a direct positioning signal.

18. A computer system, comprising:
a processor; and
a memory comprising a plurality of program instructions which, when executed by the processor, cause the processor to:
receive initial positions of an acoustic positioning source and an acoustic positioning receiver of an acoustic positioning system in a seismic spread;
calculate an expected travel difference between the acoustic positioning source and the acoustic positioning receiver;
receive a first acoustic positioning signal and a second acoustic positioning signal from the acoustic positioning receiver;
calculate an actual travel difference between the acoustic positioning source and acoustic positioning receiver based on the first and second acoustic positioning signals;
compare the actual travel difference to the expected travel difference; and
based on the comparison, identify whether the first acoustic positioning signal, the second acoustic positioning signal, or both are reflected positioning signals.

19. The computer system of claim 18, wherein the program instructions which, when executed by the processor, cause the computer to calculate the actual travel difference further comprise program instructions which, when executed by the processor, cause the computer to:
calculate a first travel distance for the first acoustic positioning signal and a second travel distance for the second acoustic positioning signal between the acoustic positioning source and the acoustic positioning receiver; and
subtract the first travel distance from the second travel distance.

20. The computer system of claim 18, wherein the program instructions which, when executed by the processor, cause the computer to identify whether the first acoustic positioning signal, the second acoustic positioning signal, or both are reflected positioning signals further comprise program instructions which, when executed by the processor, cause the computer to:
if the actual travel difference is a negative value, identify the first acoustic positioning signal as a reflected positioning signal if the actual travel difference is within negative predetermined percentages of the expected travel difference; and
identify the second acoustic positioning signal as a direct positioning signal.
